(19) United States
(12) Patent Application Publication
(10) Pub. No.: US 2020/0070736 A1
(43) Pub. Date: Mar. 5, 2020

(54) DISPLAY DEVICE FOR AUTONOMOUS VEHICLE

(71) Applicant: VTOUCH CO., LTD., Seoul (KR)

(72) Inventor: Seok Joong KIM, Seoul (KR)

(73) Assignee: VTOUCH CO., LTD., Seoul (KR)

(21) Appl. No.: 16/251,211

(22) Filed: Jan. 18, 2019

(30) Foreign Application Priority Data
Aug. 28, 2018 (KR) 10-2018-0101614

(51) Int. Cl. B60R 11/02; B60K 35/00

(52) U.S. Cl. CPC B60R 11/0235; B60R 2011/0028; B60K 35/00

(57) ABSTRACT

A display device for an autonomous vehicle includes a display unit mounted in a ceiling of the vehicle and including at least one display; and a position adjustment unit configured to move a position of at least one display of the display unit. The at least one display of the display unit is moved by the position adjustment unit between a first position in which a screen is disposed toward a ceiling or floor of the vehicle and a second position in which a screen is disposed toward each of seats facing each other. At least one display of the display unit is disposed such that the screen faces the front and the rear of the vehicle at the second position.

### CROSS-REFERENCE TO RELATED APPLICATION

This application claims priority to and the benefit of Korean Patent Application No. 10-2018-0101614 filed on Aug. 28, 2018, the disclosure of which is incorporated herein by reference in its entirety.

### BACKGROUND

The present invention relates to a display device for an autonomous vehicle, and more particularly, to a display device for an autonomous vehicle that can provide a screen to passengers within the vehicle seated to face each other by changing a position of a display in the autonomous vehicle.

Nowadays, when a driver sets only a destination without manipulation of a vehicle, an autonomous vehicle that runs itself has been in the spotlight as a next generation vehicle. Therefore, many companies from traditional automakers to IT companies are actively developing autonomous vehicles and various technologies that may be applied thereto.

In a general vehicle, all seats including a driver's seat are disposed toward the front of the vehicle, and when a display is installed in such a vehicle, the display is usually installed at the front of the vehicle for viewing of all passengers or just behind the driver's seat for viewing of passengers, except for the driver. However, because the autonomous vehicle does not require a driver's seat for manipulating the vehicle, a front seat may be designed to face a back seat toward the rear of the vehicle so that passengers may have a conversation with each other or have a meeting when the autonomous vehicle runs unlike a general seat structure of a vehicle.

However, according to a seat disposition of such an autonomous vehicle, when a display is disposed in the same manner as the conventional method, some passengers may suffer difficulty in viewing a screen, and a shape or movement of the other passengers enters at the sight of passengers facing the screen and thus passengers may be disturbed in immersing in the screen and may feel psychological discomfort.

Accordingly, it is necessary to improve a structure of a display device in order to enable to comfortably view a screen in all seats of an autonomous vehicle.

### PRIOR ART DOCUMENT

### Patent Document

(Patent Document 0001) Korea Patent Registration No. 10-1457225 (Oct. 27, 2014)

### SUMMARY

The present invention has been made to solve the above-mentioned problems of the prior art and provides a display device capable of comfortably viewing a screen in all seats and providing a sufficient viewing angle in an autonomous vehicle.

The present invention further provides a display device capable of efficiently using an internal space of a vehicle without obstructing activity of passengers when a display is not used.

In an aspect, a display device for an autonomous vehicle is provided. The display device includes a display unit mounted in a ceiling of the vehicle and including at least one display; and a position adjustment unit configured to move a position of at least one display of the display unit. Here, at least one display of the display unit is moved by the position adjustment unit between a first position in which a screen is disposed toward a ceiling or floor of the vehicle and a second position in which a screen is disposed toward each of seats facing each other.

At least one display of the display unit may be disposed such that the screen faces the front and the rear of the vehicle at the second position.

The position adjustment unit may include a guide rail, one end of at least one display of the display unit may be fixedly connected to the guide rail, and when one end of at least one display of the display unit fixedly connected to the guide rail moves along the guide rail, at least one display of the display unit may move between the first position and the second position.

The display unit may include two displays, and the two displays may be connected to each other through a hinge. Alternatively, the display unit may include four displays, and any two adjacent displays of the four displays may be connected to each other through a hinge.

The display unit may include two displays, the two displays may be connected to each other through a hinge, and the two displays may move between the first position and the second position with rotation of the two displays about the hinge.

The display unit may include two displays, and the two displays may be detachably coupled to each other.

At least one display of the display unit for the autonomous vehicle may be formed in a flexible display. Further, at least one display of the display unit may be formed in a transparent display that can adjust transmittance of light.

Different screens may be provided to passengers positioned side by side toward one display of the display unit.

### BRIEF DESCRIPTION OF THE DRAWINGS

FIG. 1 is a diagram illustrating the inside of a vehicle mounted with a display device for an autonomous vehicle according to a first embodiment of the present invention.

FIG. 2 is a diagram illustrating a display device for an autonomous vehicle according to a first embodiment of the present invention.

FIGS. 3 to 6 are diagrams illustrating a use state of a display device for an autonomous vehicle according to a first embodiment of the present invention.

FIG. 7 is a diagram illustrating a process of opening and closing a display device for an autonomous vehicle in a vehicle ceiling according to a first embodiment of the present invention.

FIG. 8 is a diagram illustrating a process of driving a display device for an autonomous vehicle according to a modified example of the first embodiment of the present invention.

FIG. 9 is a diagram illustrating a process of driving a display device for an autonomous vehicle according to a second embodiment of the present invention.

FIG. 10 is a diagram illustrating a process of driving a display device for an autonomous vehicle according to a third embodiment of the present invention.

FIG. 11 is a diagram illustrating a process of opening and closing a display device for an autonomous vehicle in a vehicle ceiling according to a third embodiment of the present invention.

FIG. 12 is a diagram illustrating the inside of a vehicle mounted with a display device for an autonomous vehicle according to a fourth embodiment of the present invention.

FIG. 13 is a diagram illustrating a process of driving a display device for an autonomous vehicle according to a fourth embodiment of the present invention.

FIG. 14 is a diagram illustrating a display device for an autonomous vehicle according to a modified example of a fourth embodiment of the present invention.

FIG. 15 is a diagram illustrating a process of driving a display device for an autonomous vehicle according to a fifth embodiment of the present invention.

FIG. 16 is a diagram illustrating a transformed state of a seat structure in an autonomous vehicle mounted with a display device.

FIG. 17 is a diagram illustrating a process of driving a pop-up table that may be mounted in an autonomous vehicle together with a display device for the autonomous vehicle according to the present invention.

### DETAILED DESCRIPTION

The present invention will be described more fully hereinafter with reference to the accompanying drawings, in which exemplary embodiments of the invention are shown.

In order to clearly describe the present invention, the description of parts not related to the present invention is omitted, and the same reference numerals are used for the same components throughout the specification.

In this specification, the connection of one element and another element is used in the sense of including not only that they are directly connected but also connected to each other through another element. Further, in the drawings, a size, thickness, and position of each element are randomly represented for better understanding and ease of description, and the present invention is not limited thereto.

In other words, specific shapes, structures, and characteristics described in the specification may be implemented by changing from an embodiment to another embodiment without departing from the spirit and scope of the present invention, and it should be understood that positions or dispositions of individual components may be changed without departing from the spirit and scope of the invention.

Accordingly, the following detailed description is not being carried out as a limiting meaning, and the scope of the invention should be taken to encompass a range of claims and a full range equivalent thereto.

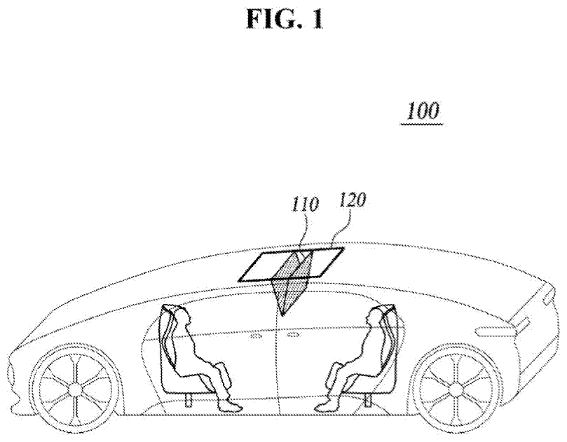

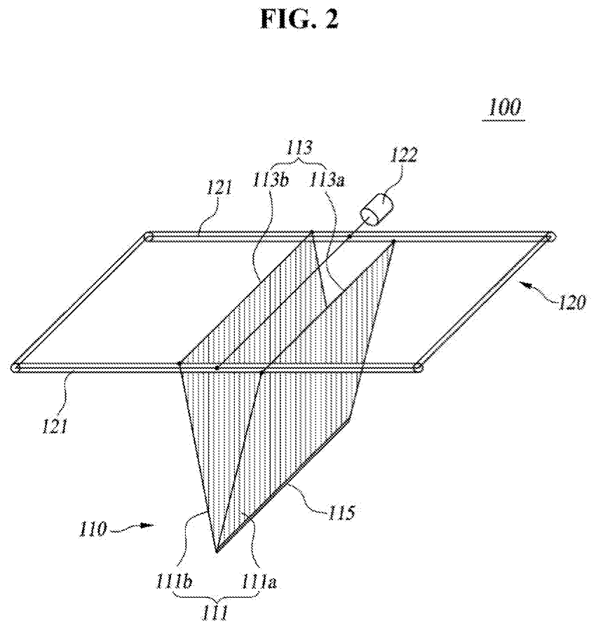

FIG. 1 is a diagram illustrating the inside of a vehicle mounted with a display device for an autonomous vehicle according to a first embodiment of the present invention. FIG. 2 is a diagram illustrating a display device for an autonomous vehicle according to a first embodiment of the present invention.

Referring to FIGS. 1 and 2, a display device 100 for an autonomous vehicle according to the first embodiment of the present invention includes a display unit 110 and a position adjustment unit 120.

According to the first embodiment of the present invention, the display unit 110 is mounted in a central portion of a vehicle ceiling, specifically, in a middle portion of seats facing each other in the vehicle. The display unit 110 may be mounted in a form exposed to a vehicle ceiling or may be provided in a separate space for housing a display in a vehicle ceiling to be mounted in a form that houses the display in a corresponding space.

The display unit 110 according to the present embodiment includes at least one display 111. In the present embodiment, the display unit 110 includes two displays 111a and 111b, and the two displays 111a and 111b each may be provided in different directions, for example, one may provide a screen toward the front of the vehicle and the other one may provide a screen toward the rear of the vehicle. Hereinafter, a display disposed toward the front of the vehicle is referred to as a first display 111a, and a display disposed toward the rear of the vehicle is referred to as a second display 111b.

According to the present embodiment, the first display 111a and the second display 111b may be connected through a hinge 115. The hinge 115 performs a function of guiding the first display 111a and the second display 111b to move toward a lower portion of the vehicle under the control of the position adjustment unit 120 to be described later. Further, the first display 111a and the second display 111b include guide bars 113a and 113b, respectively installed at the opposite end by the hinge 115 and are connected to a position adjustment unit 120 to be described later.

The position adjustment unit 120 of the display device 100 for an autonomous vehicle according to the first embodiment of the present invention performs a function of controlling a position of the display unit 110. Specifically, the position adjustment unit 120 may control the display unit 110 to move between a position (hereinafter, referred to as a first position) in which the first display 111a and the second display 111b are disposed toward a lower portion of the vehicle and a position (hereinafter, referred to as a second position) in which the first display 111a and the second display 111b are disposed toward the front and rear, respectively of the vehicle.

For this reason, the position adjustment unit 120 may include a guide rail 121 and a driving motor 122. According to the present embodiment, the guide rail 121 includes a belt, and the belt may move in one direction by driving the drive motor 122. Further, each of the guide bars 113a and 113b of the first display 111a and the second display 111b is fixedly connected to belts of the guide rails 121 to move along the guide rail by a movement of the belt.

According to the present embodiment, the guide bar 113a of the first display 111a and the guide bar 113b of the second display 111b are mounted in different surfaces of the belt. For example, as shown, the guide bar 113a of the first display 111a may be installed in a lower surface of the belt, and the guide bar 113b of the second display 111b may be installed in an upper surface of the belt.

Accordingly, when the belt moves clockwise by the drive motor 122, the guide bar 113a of the first display 111a moves to the right and the guide bar 113b of the second display 111b moves to the right and thus two displays 111a and 111b move downward, and in contrast, when the belt moves counterclockwise by the drive motor 122, the guide bar 113a of the first display 111a moves to the right, and the guide bar 113b of the second display 111b moves to the left and thus the two displays 111a and 111b move upward.

In the present embodiment, it is illustrated that the guide rail 121 includes one belt and that the drive motor 122 drives one belt to collectively control a movement of the two guide bars 113a and 113b, but the guide rail includes two belts and the guide bar is connected to each of the two belts and thus a movement of the guide bar may be individually controlled. Further, a belt in the present embodiment may be replaced with another transport means, for example, a chain.

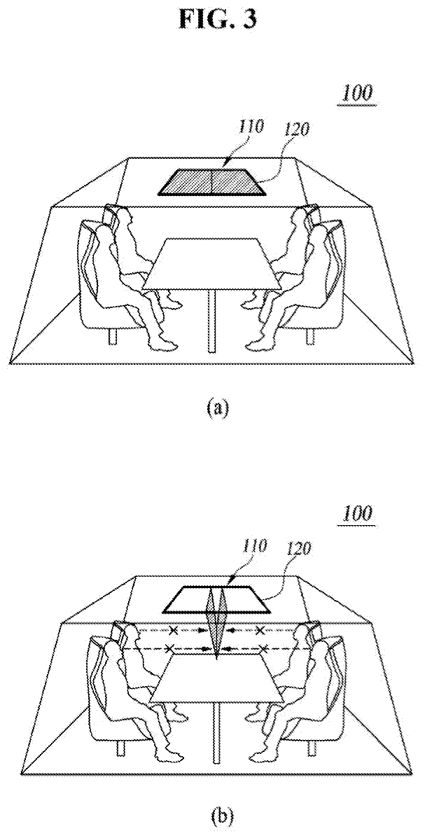

FIGS. 3 to 6 are diagrams illustrating a use state of a display device for an autonomous vehicle according to a first embodiment of the present invention.

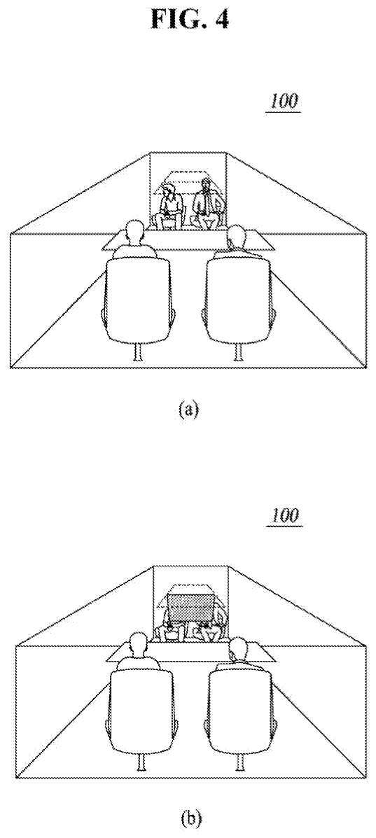

Referring to FIGS. 3 and 4, in a state in which the display unit 110 is not used, a screen of the display unit 110 is positioned at a first position that comes in close contact with the ceiling while facing the floor of the vehicle (see FIGS. 3A and 4A). In this way, when the display unit 110 is not used, the display unit 110 comes in close contact with the vehicle ceiling and does not block the sight of passengers facing each other, thereby not disturbing a conversation or other activity of passengers.

When the display unit 110 is used, the guide bars 113a and 113b of the displays 111a and 111b move to the center along the guide rails 121 as described above, and the first display 111a and the second display 111b move downward about the hinge 115 to be positioned at the second position (see FIGS. 3B and 4B).

Accordingly, the first display 111a and the second display 111b provide screens in forward and backward directions, respectively of the vehicle. In this case, the first display 111a and the second display 111b block the sight of passengers facing each other, thereby preventing a disturbance of immersion by a movement of other passengers and psychological discomfort according to the disturbance.

According to the first embodiment of the present invention, in order to enable the passenger to view a screen in a more comfortable state, an angle formed by the first display 111a and the second display 111b may be adjusted in consideration of the passenger's posture and eye level.

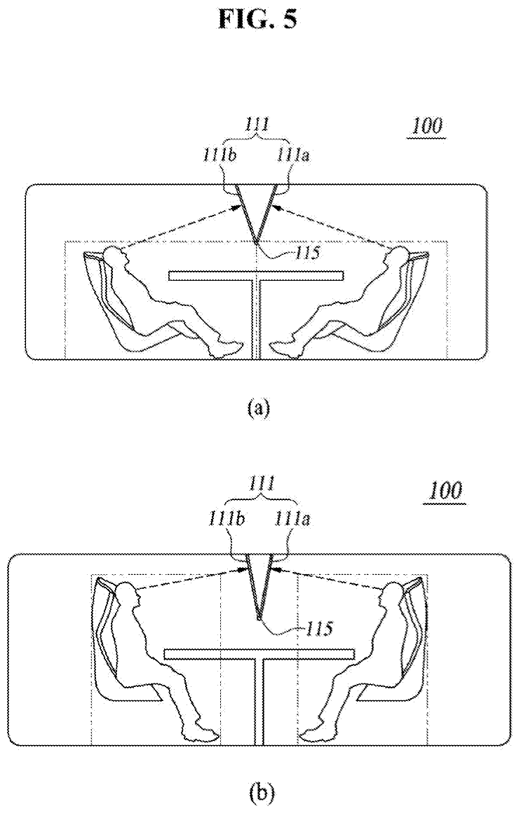

For example, referring to FIG. 5, in a state in which a seat is titled as shown in FIG. 5A, an angle formed by a first display 111a and a second display 111b may be formed relatively large such that a display screen enters into an entire surface of the passenger's sight, and in a state in which a seat is stood as shown in FIG. 5B, an angle formed by the first display 111a and the second display 111b may be formed relatively small.

According to the first embodiment of the present invention, when it is necessary to dispose a display toward the front and rear of the vehicle, different images may be provided to facing passengers. Further, according to the present embodiment, different images may be provided to passengers positioned side by side toward one display.

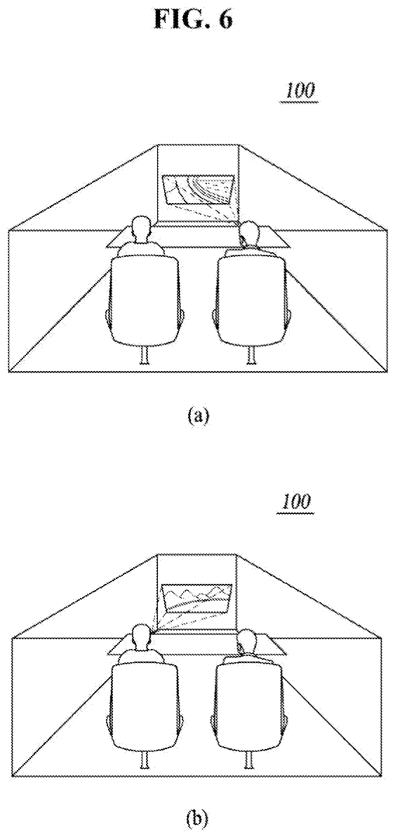

Referring to FIG. 6, two passengers positioned side by side view one display, but different images are provided to two passengers according to a viewing direction of the display. This may be implemented using the principle of a 3D display that injects different images into both eyes. For example, in the present embodiment, different images may be provided according to a viewing direction of a display using a non-glass type parallax barrier method, a lenticular lens method, a glass type polarization glass method, and a shutter glass method.

According to the first embodiment of the present invention, the display device for an autonomous vehicle may be transformed into a form opened in the ceiling.

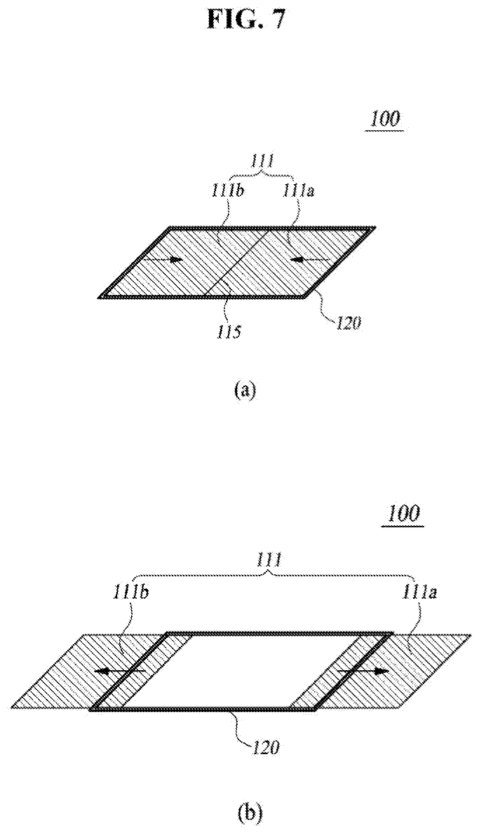

FIG. 7 is a diagram illustrating a process of opening and closing a display device for an autonomous vehicle in a vehicle ceiling according to a first embodiment of the present invention. Referring to FIG. 7, the first display 111a and the second display 111b of the display unit 110 may be installed detachably from each other with the hinge 115 interposed therebetween to move in a direction receding from each other under the control of the position adjustment unit 120. That is, the display unit 110 may move to a position (hereinafter, referred to as a third position) in which the first display 111a and the second display 111b are separated from each other and in which a central portion thereof is opened. While the display unit 110 moves to the third position in which a central portion thereof is opened, when a sunroof installed in the vehicle ceiling operates, the vehicle ceiling may be opened.

In the foregoing embodiment, it is described that the display unit 110 includes two displays 111a and 111b, but the display unit may have more displays.

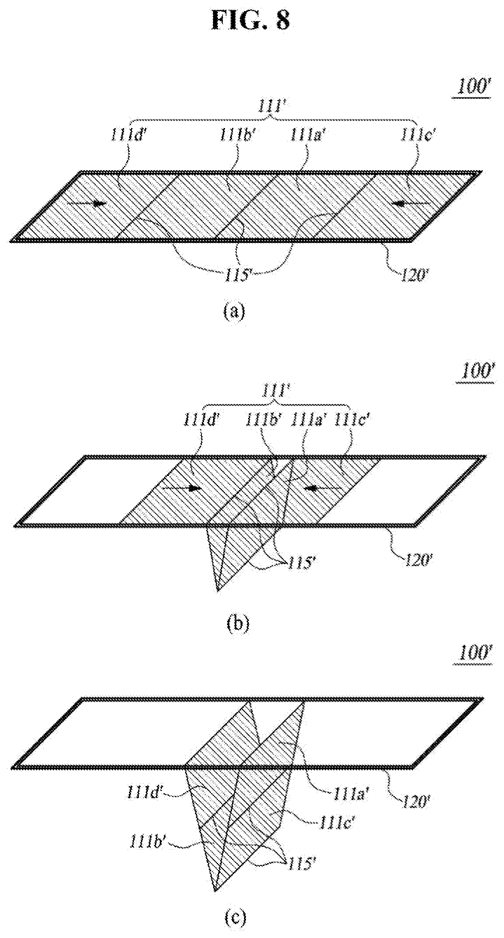

FIG. 8 is a diagram illustrating a process of driving a display device for an autonomous vehicle according to a modified example of the first embodiment of the present invention. A display device 100′ for an autonomous vehicle according to the present modified example includes a display unit 110′ and a position adjustment unit 120′, and the display unit 110′ includes four displays 111a′, 111b′, 111c′, and 111d′. Two adjacent displays among the four displays 111a′, 111b′, 111c′, and 111d′ of the display unit 110′ are connected through a hinge 115′.

The display device 100′ for an autonomous vehicle according to this modified example may provide a display in the same manner as the display device 100 in the above-described embodiment, and by controlling the number of displays moving downward, a size of the screen provided toward the front and rear of the vehicle may be adjusted. For example, as shown in FIG. 8B, by moving downward only the first display 111a′ and the second display 111b′, a relatively small screen may be provided, or as shown in FIG. 8C, by moving downward all of the first display 111a′ to the fourth display 111d′, a relatively large screen may be provided.

In this modified example, it is described that the display unit 110′ includes four displays 111a′, 111b′, 111c′, and 111d′, but the number of displays is not limited thereto and in order to variously adjust a size of the screen, more displays may be included.

Hereinafter, other embodiments of the present invention will be described with reference to the drawings. When describing other embodiments of the present invention, a description of the same configuration as that of the first embodiment of the present invention will be omitted.

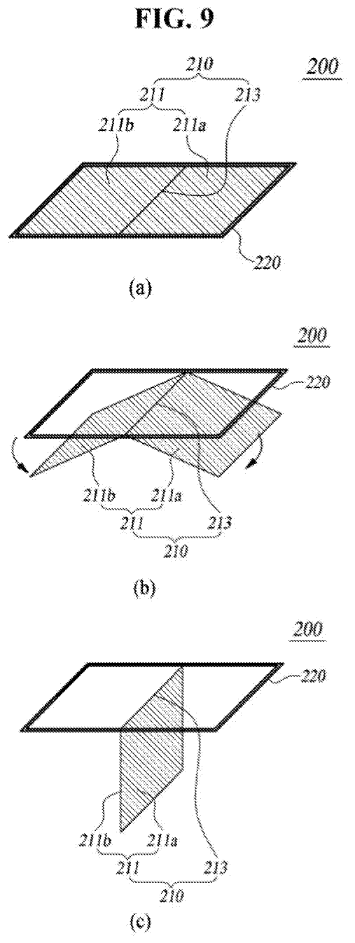

FIG. 9 is a diagram illustrating a process of driving a display device for an autonomous vehicle according to a second embodiment of the present invention. Referring to FIG. 9, a display device 200 for an autonomous vehicle according to the present embodiment includes a display unit 210 and a position adjustment unit 220.

In the second embodiment of the present invention, the display unit 210 includes a first display 211a and a second display 211b, but the second embodiment is different from the first embodiment in that in a state in which the display unit 210 is not used, the first display 211a and the second display 211b are mounted such that a screen faces the vehicle ceiling.

In the present embodiment, through the position adjustment unit 220, a position of the display unit 210 is controlled between a first position in which the display unit 210 is not used and a second position in which the display unit 210 is used. However, in the present embodiment, a hinge 213 connecting the first display 211a and the second display 211b is fixed to a ceiling, and the position adjustment unit 220 moves the display unit 210 with a method of rotating the first display unit 211a and the second display unit 211b about the hinge 213.

A process of driving the display device 200 for an autonomous vehicle according to the second embodiment of the present invention will be described in detailed. As shown in FIG. 9A, when the display unit 210 is not used, each display screen is positioned at a first position facing the ceiling.

Thereafter, in order to use the display unit 210, when a movement command of the displays 211a and 211b is given through the position adjustment unit 220, as shown in FIG. 9B, in a state in which the hinge 213 is fixed to the vehicle ceiling, one ends of the first display 211a and the second display 211b rotate clockwise and counterclockwise, respectively about the hinge 213.

Finally, as shown in FIG. 9C, when the first display 211a and the second display 211b move to the second position, the first display 211a and the second display 211b may provide respective screens in forward and backward directions of the vehicle.

When use of the display unit 210 is complete, by performing the above process in reverse order, the display unit 210 may move again to the first position.

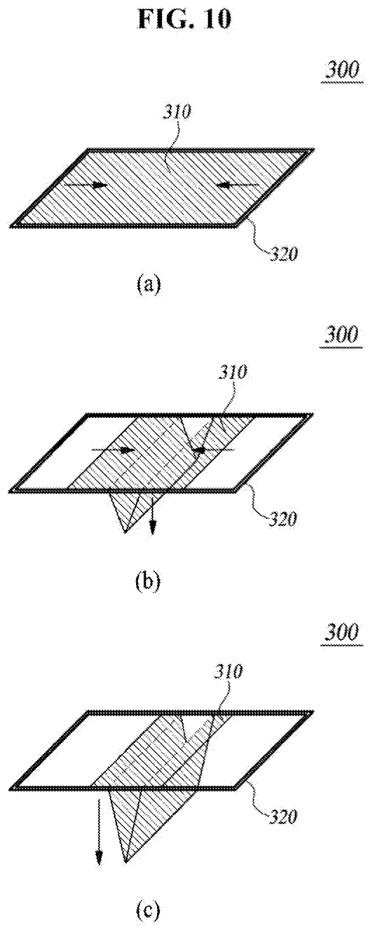

FIG. 10 is a diagram illustrating a process of driving a display device for an autonomous vehicle according to a third embodiment of the present invention. Referring to FIG. 10, a display device 300 for an autonomous vehicle according to the present embodiment includes a display unit 310 and a position adjustment unit 320.

According to a third embodiment of the present invention, the display 300 includes a flexible display, and a shape thereof may be flexibly transformed by an external force. Further, in the present embodiment, the display unit 310 may be formed with a single display unlike the above-described embodiments.

According to the present embodiment, the position adjustment unit 320 may include a guide (not shown) and a driver (not shown), as in the first embodiment of the present invention, and in a state in which both ends of the flexible display are fixed by the guide, when the guide is driven by the driver, the flexible display may move.

FIG. 10A illustrates a state before using the display unit 310, and in the flexible display, a screen is in a first position facing the bottom of the vehicle.

In this case, in order to use the display unit 310, when the guide is driven through the position adjustment unit 220, both ends of the flexible display move to a central portion (arrow direction) along the guide, and a central portion of the flexible display is pushed downward, as shown in FIG. 10B.

When the flexible display completes a movement and finally moves to the second position, the screen may be provided in forward and backward directions of the vehicle. Here, a flexible display screen is divided into two, and each image may be provided toward the front and rear.

In the present embodiment, by controlling a movement level of the flexible display through the position adjustment unit 320, a size of the screen provided to the passenger may be adjusted.

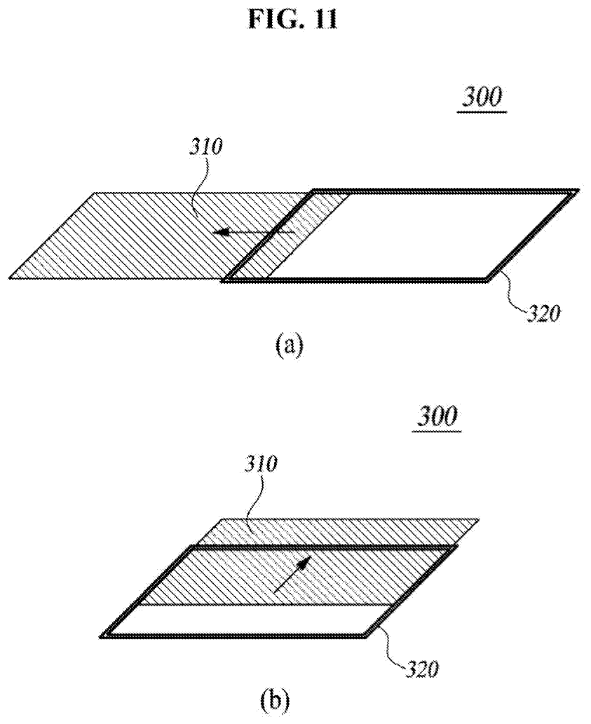

FIG. 11 is a diagram illustrating a process of opening and closing a display device for an autonomous vehicle in a vehicle ceiling according to a third embodiment of the present invention. Referring to FIG. 11, in the present embodiment, the display unit 310 may be opened in a method of moving in one body unlike the embodiment described with reference to FIG. 7. A moving direction of the display unit 310 may be a front or rear direction of the vehicle (i.e., a running direction of the vehicle), as shown in FIG. 11A or may be a lateral direction of the vehicle, as shown in FIG. 11B.

In the above-described embodiments, it is described that the ceiling is opened with a movement of the display unit, but the display unit may be formed with a transparent display and thus external light may enter into the display unit by penetrating the display unit. In this case, by controlling transmittance of the display by providing a separate penetration adjustment unit, an amount of penetrated light may be controlled. In this way, when the display unit is formed with a transparent display, by controlling a background screen of the display and a color and brightness of lighting, the interior of the vehicle may be implemented in various forms.

In the above-described embodiments, each screen is provided in the front of passengers facing each other in the autonomous vehicle, but a screen may be provided at the side of passengers.

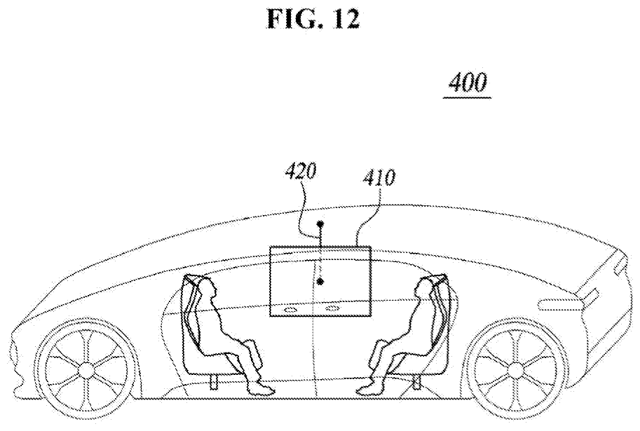

FIG. 12 is a diagram illustrating the inside of a vehicle mounted with a display device for an autonomous vehicle according to a fourth embodiment of the present invention. Referring to FIG. 12, a display device 400 for an autonomous vehicle according to the present embodiment includes a display unit 410 and a position adjustment unit 420.

As shown in FIG. 12, in the display device 400 for an autonomous vehicle according to the present embodiment, when the display unit 410 is used, by moving the display unit 410 to the side of the vehicle, the same single screen is provided to all passengers in the vehicle.

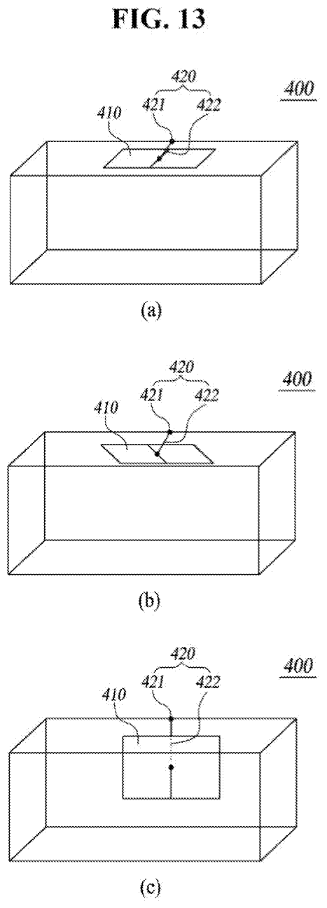

FIG. 13 is a diagram illustrating a process of driving a display device for an autonomous vehicle according to a fourth embodiment of the present invention. Referring to FIG. 13, in a display device 400 for an autonomous vehicle according to the present embodiment, a position of the display is moved through rotation driving of the position adjustment unit 420.

For this reason, the position adjustment unit 420 includes a fixing portion 421 fixedly mounted at one corner of the ceiling of the vehicle and a connection portion 422 having one end connected to the fixing portion 421 and the other end connected to the display unit 410.

A process of moving the display unit 410 according to the present embodiment will be described in detail. Before the display unit 410 is used, the display unit 410 is disposed at a position in which a display screen comes in close contact with the ceiling while facing the bottom (see FIG. 13A). In order to use the display unit 410, when a movement command of the display unit 410 is given through the position adjustment unit 420, the connection portion 422 of the position adjustment unit 420 rotates about the fixing portion 421 and thus the display unit 410 connected to the connection portion 422 is moved laterally from the vehicle ceiling (see FIG. 13B).

Thereafter, as shown in FIG. 13C, when the connecting portion 422 of the position adjustment unit 420 stops moving, the display unit 410 is positioned at the side of the vehicle (second position), and the display unit 410 provides a single screen to the passengers at the side of the vehicle.

In the embodiment of FIG. 13, the position adjustment unit includes one connection portion, but the present embodiment is not limited thereto.

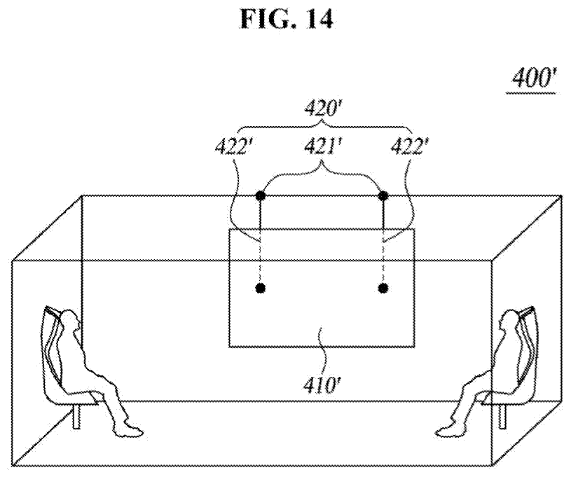

FIG. 14 is a diagram illustrating a display device for an autonomous vehicle according to a modified example of a fourth embodiment of the present invention. Referring to FIG. 14, a position adjustment unit 420′ of a display device 400′ for an autonomous vehicle may include two fixing portions 421′ fixed to corners of one side of the vehicle ceiling and two connecting portions 422′ connected to a display unit 410′.

In this way, the number of the fixing portions and the connecting portions of the position adjustment unit for moving the display unit between the ceiling and the side surface of the vehicle may be variously changed, and other known connecting members may be used to constitute the position adjustment unit.

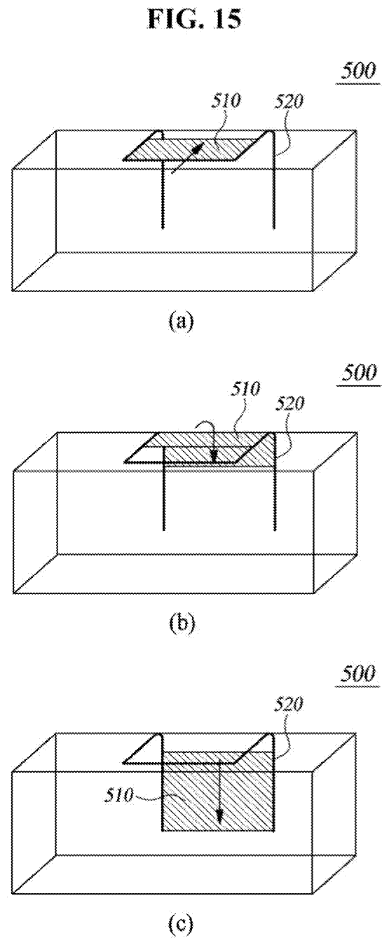

FIG. 15 is a diagram illustrating a process of driving a display device for an autonomous vehicle according to a fifth embodiment of the present invention. Referring to FIG. 15, a display device 500 according to the present embodiment includes a display unit 510 and a position adjustment unit 520. Further, the display unit 510 may include a flexible display, and the position adjustment unit 520 may include a guide (not shown) and a driver (not shown) for moving the flexible display. By such a configuration, the display unit 510 may move between the ceiling (first position) of the vehicle and the side surface (second position) of the vehicle along the guide of the position adjustment unit 520.

Specifically, FIG. 15A illustrates a state before the display unit 510 is used, and the flexible display of the display unit 510 is at a position (first position) in which the screen faces the floor of the vehicle. Here, in order to use the display unit 510, when the guide is driven through the position adjustment unit 520, the flexible display moves to the vehicle side of an arrow direction along the guide (see FIG. 15B), and when the movement is complete, the flexible display is positioned at the vehicle side (second position) (see FIG. 15C).

In the present embodiment, because the display unit 510 is formed with the flexible display, the display unit 510 may move with bent according to a corner shape even in a corner segment formed in a path that moves the display unit 510 from the first position to the second position.

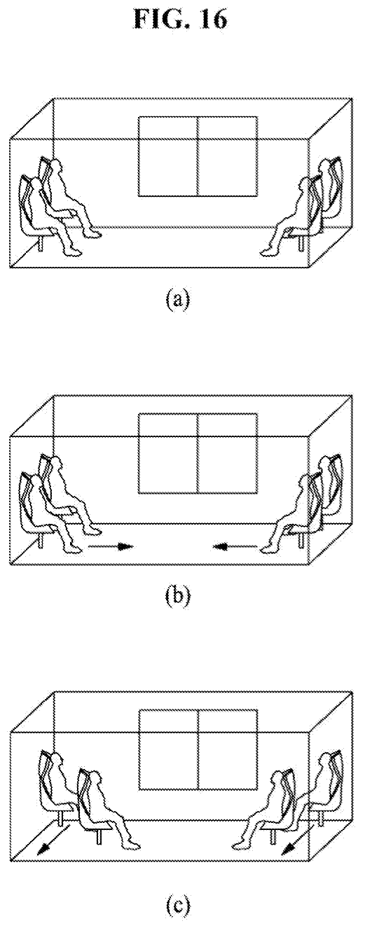

FIG. 16 is a diagram illustrating a transformed state of a seat structure in a vehicle mounted with a display device for an autonomous vehicle. In particular, as in the fourth embodiment and the fifth embodiment of the present invention, when the display is positioned at a side surface of the vehicle to provide a screen, the seat structure is transformed.

As shown in FIG. 16A, when the screen is provided by moving the display to the side of the vehicle, a passenger positioned relatively close to the screen may be positioned too close to the screen to experience difficulties in viewing the screen. Further, a passenger positioned relatively far away from the screen may be disturbed by a passenger positioned relatively close to the screen in viewing the screen.

In the present embodiment, in order to solve such a problem, when a display screen is provided at the side of the vehicle, a position of a seat positioned relatively far away from the screen may be moved to the center of the vehicle (see FIG. 16B), and a position of the seat positioned relatively close to the screen may be moved in a direction receding from the side in which the screen is positioned (see FIG. 16C). By changing a seat structure in this way, even when a display screen is provided at the side of the vehicle, a sufficient viewing angle may be provided to all passengers inside the vehicle.

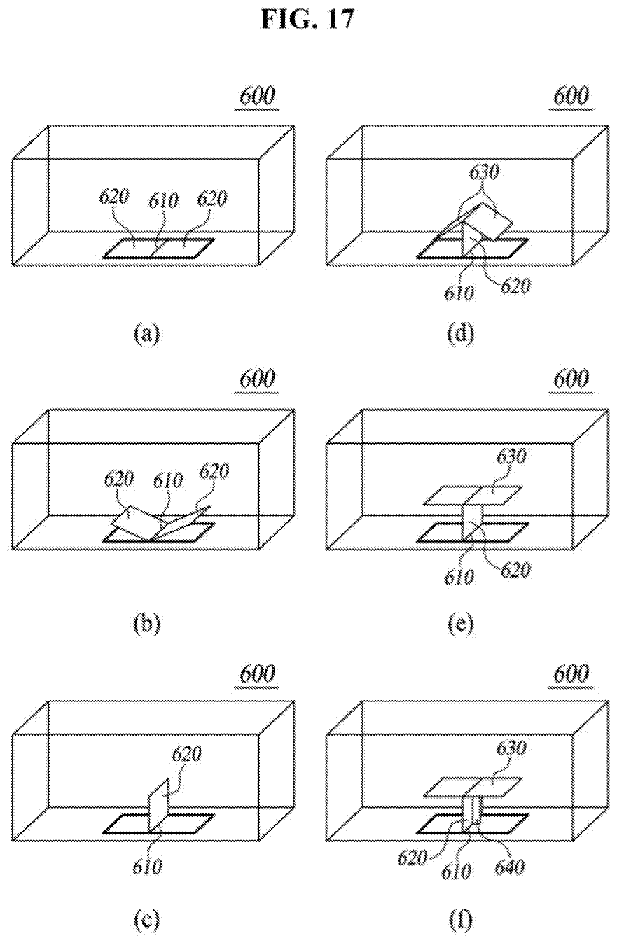

FIG. 17 is a diagram illustrating a process of driving a pop-up table that may be mounted in an autonomous vehicle together with a display device for an autonomous vehicle according to the present invention.

Referring to FIG. 17, a pop-up table 600 may be mounted with inserted into a lower portion of the vehicle when not in use and may be automatically and/or manually installed between a front seat and a rear seat within the vehicle when in use. For this reason, the pop-up table 600 may include a hinge 610, two frames 620 connected by the hinge 610, tables 630 each mounted at one side of the frame, and a support 640 for supporting the frame.

An installing process of the pop-up table 600 will be described in detail. When the pop-up table 600 is not used, the pop-up table 600 is disposed at the bottom of the vehicle (see FIG. 17A). Thereafter, when two frames 620 supporting the pop-up table 600 are stood, two frames 620 each rotate with the hinge 610 fixed to the floor and thus the two frames 620 are vertically stood and come in contact with each other (see FIGS. 17B and 17C). Thereafter, when the tables 630 mounted in each of the two frames 620 are spread, installation of the pop-up table 600 is complete (see FIGS. 17D and 17E). In addition, in order to more stably support the pop-up table 600, a support 640 may be further installed in the frame 620 (see FIG. 17F).

When the pop-up table 600 is not used, by reversely performing the above-described installation process, the pop-up table 600 may be disposed at the floor.

While the present invention has been particularly shown and described with reference to exemplary embodiments thereof, it is to be understood that the invention is not limited to the disclosed embodiments, but, on the contrary, those skilled in the art will appreciate that various modifications and changes may be made thereto without departing from the spirit and scope of the invention. For example, a configuration applied to any one embodiment may be applied to another embodiment, and the configuration may be partially modified and applied.

Accordingly, the spirit of the present invention should not be limited to the foregoing embodiments, and claims to be described later and all contents equally or equivalently modified to the claims belong to a range of the scope of the present invention.

In a display device for an autonomous vehicle according to an embodiment of the present invention, while a display is disposed toward a ceiling or a floor of the vehicle, by disposing the display to face each of seats facing each other by a position adjustment unit upon using the display, a screen can be comfortably viewed at all seats and a sufficient viewing angle can be provided.

Further, when the display is not used, by disposing the display to face a ceiling or a floor of the vehicle, an internal space of the vehicle can be efficiently used without obstructing activity of the passenger.

### DESCRIPTION OF SYMBOLS

100, 100′, 200, 300, 400, 400′, 500: display device for autonomous vehicle
110, 110′, 210, 310, 410, 410′, 510: display unit
120, 120′, 220, 320, 420, 420′, 520: position adjustment unit
600: pop-up table
610: hinge
620: frame
630: table
640: support

What is claimed is:

1. A display device for an autonomous vehicle, the display device comprising:
a display unit mounted in a ceiling of the vehicle and comprising at least one display; and
a position adjustment unit configured to move a position of at least one display of the display unit,
wherein at least one display of the display unit is moved by the position adjustment unit between a first position in which a screen is disposed toward a ceiling or floor of the vehicle and a second position in which the screen is disposed toward each of seats facing each other.

2. The display device of claim 1, wherein at least one display of the display unit is disposed such that the screen faces the front and the rear of the vehicle at the second position.

3. The display device of claim 1, wherein the position adjustment unit comprises a guide rail,
one end of at least one display of the display unit is fixedly connected to the guide rail, and
at least one display of the display unit moves between the first position and the second position when one end of at least one display of the display unit fixedly connected to the guide rail moves along the guide rail.

4. The display device of claim 3, wherein the display unit comprises two displays, and the two displays are connected to each other through a hinge.

5. The display device of claim 3, wherein the display unit comprises four displays, and any two adjacent displays of the four displays are connected to each other through a hinge.

6. The display device of claim 1, wherein the display unit comprises two displays, the two displays are connected to each other through a hinge, and the two displays move between the first position and the second position with rotation of the two displays about the hinge.

7. The display device of claim 1, wherein the display unit comprises two displays, and the two displays are detachably coupled to each other.

8. The display device of claim 1, wherein at least one display of the display unit is formed in a flexible display.

9. The display device of claim 1, wherein at least one display of the display unit is formed in a transparent display that can adjust transmittance of light.

10. The display device of claim 1, wherein different screens are provided to passengers positioned side by side toward one display of the display unit.
